(19) United States
(12) Patent Application Publication
(10) Pub. No.: US 2025/0102819 A1
(43) Pub. Date: Mar. 27, 2025

(54) HIGH-POWER OPTICAL MODULE WITH SINGLE EMITTER CHIPS AND DOVE PRISMS

(71) Applicant: Lumentum Operations LLC, San Jose, CA (US)

(72) Inventor: John G. BAI, San Jose, CA (US)

(21) Appl. No.: 18/510,107

(22) Filed: Nov. 15, 2023

Related U.S. Application Data
(60) Provisional application No. 63/584,251, filed on Sep. 21, 2023.

(51) Int. Cl. G02B 27/09; G02B 5/04

(52) U.S. Cl. CPC G02B 27/0955; G02B 5/04; G02B 27/0916

(57) ABSTRACT

In some implementations, a high-power optical module includes multiple optical devices arranged in an array to generate multiple laser beams, where the multiple optical devices each include a diode laser with a single emitter to emit a laser beam; a fast axis collimation (FAC) lens arranged to collimate the laser beam in a fast axis; a slow axis collimation (SAC) lens, arranged after the FAC lens, to collimate the laser beam in a slow axis; and a Dove prism arranged between the FAC lens and the SAC lens. The Dove prism includes an axis that is rotated 45 degrees relative to the single emitter such that an orientation of the fast axis and an orientation of the slow axis of the laser beam are rotated 90 degrees after the laser beam passes through the Dove prism.

### CROSS-REFERENCE TO RELATED APPLICATION

This patent application claims priority to U.S. Provisional Patent Application No. 63/584,251, filed on Sep. 21, 2023, and entitled “HIGH-POWER OPTICAL MODULE WITH SINGLE EMITTER CHIPS AND DOVE PRISMS.” The disclosure of the prior application is considered part of and is incorporated by reference into this patent application.

### TECHNICAL FIELD

The present disclosure relates generally to high-power fiber-coupled diode laser modules for pump applications and to a laser module with single emitter chips and Dove prisms to rotate and stack laser beams in a fast axis direction.

### BACKGROUND

In an optical system, beam quality generally refers to a measure of how tightly a laser beam can be focused under certain conditions (e.g., with a limited beam divergence). For example, a high beam quality implies smooth wavefronts (e.g., a strong phase correlation across the beam profile) such that focusing the beam with a lens enables the beam to be focused where the wavefronts are planar. On the other hand, a beam with poor beam quality may have scrambled wavefronts that make beam focusing more difficult (e.g., the beam divergence for a given spot size is increased). One metric that is often used to quantify beam quality is a beam parameter product (BPP), which is defined as the product of the beam radius (measured at the beam waist) and the beam divergence half-angle (measured in the far field). In general, beam quality decreases as the BPP value increases and vice versa (e.g., a higher BPP is associated with a lower beam quality and a lower BPP is associated with a higher beam quality), where the minimum achievable BPP value is λ/π, which corresponds to an ideal Gaussian beam with a wavelength 2. For example, the minimum possible BPP value for a beam that has a 1064 nanometer (nm) wavelength is about 0.339 millimeters times milliradians (mm-mrad). In some cases, the BPP may remain unchanged or may increase minimally (e.g., does not get worse) when a beam is sent through non-aberrative optics, such as a thin lens (e.g., if the lens generates a focus with a smaller radius or a larger radius at the beam waist, the beam divergence will increase or decrease correspondingly). However, non-ideal optics can lead to a significant increase in the BPP value, which can spoil the beam quality. For example, the BPP value can significantly increase in cases where one or more optical components cause the beam radius to increase without a corresponding decrease in the beam divergence half-angle.

### SUMMARY

In some implementations, an optical module includes a diode laser that includes a single emitter configured to emit a laser beam in a beam propagation direction, wherein the single emitter has a fast axis oriented perpendicular to a top surface of the single emitter and a slow axis oriented parallel to the top surface of the single emitter; a fast axis collimation (FAC) lens arranged to collimate the laser beam in the fast axis; a slow axis collimation (SAC) lens, arranged after the FAC lens, to collimate the laser beam in the slow axis; and a Dove prism arranged between the FAC lens and the SAC lens, wherein the Dove prism includes an axis that is rotated 45 degrees relative to the single emitter such that an orientation of the fast axis and an orientation of the slow axis of the laser beam are rotated 90 degrees after the laser beam passes through the Dove prism.

In some implementations, an optical assembly includes a polarization beam combiner (PBC), a fast axis coupling lens (FCL), and a slow axis coupling lens (SCL) arranged to couple multiple laser beams into an optical fiber; and an array that includes multiple optical devices arranged in a first row and a second row to generate the multiple laser beams, wherein the multiple optical devices each include: a diode laser that includes a single emitter configured to emit a laser beam, of the multiple laser beams, in a beam propagation direction; a FAC lens arranged to collimate the laser beam in a fast axis; a SAC lens, arranged after the FAC lens, to collimate the laser beam in a slow axis; a Dove prism arranged between the FAC lens and the SAC lens; and a mirror, arranged after the SAC lens, to direct the laser beam toward the PBC, the FCL, and the SCL, wherein the Dove prism includes an axis that is rotated 45 degrees relative to the single emitter such that an orientation of the fast axis and an orientation of the slow axis of the laser beam are rotated 90 degrees after the laser beam passes through the Dove prism.

In some implementations, an optical assembly includes an FCL and an SCL arranged to couple multiple laser beams into an optical fiber; and an array that includes multiple optical devices arranged in a first row and a second row to generate the multiple laser beams, wherein the multiple optical devices each include: a diode laser that includes a single emitter configured to emit a laser beam, of the multiple laser beams, in a beam propagation direction; a FAC lens arranged to collimate the laser beam in a fast axis; a SAC lens, arranged after the FAC lens, to collimate the laser beam in a slow axis; a Dove prism arranged between the FAC lens and the SAC lens; and a mirror, arranged after the SAC lens, to direct the laser beam toward the FCL and the SCL, wherein the Dove prism includes an axis that is rotated relative to the single emitter such that an orientation of the fast axis and an orientation of the slow axis of the laser beam are rotated after the laser beam passes through the Dove prism.

### BRIEF DESCRIPTION OF THE DRAWINGS

FIG. 1 illustrates an example of an optical system for collimation of a single laser beam.

FIG. 2A illustrates an example of a multi-chip package structure.

FIG. 2B illustrates an example of an optical layout for a pump module based on the multi-chip package structure illustrated in FIG. 2A.

FIGS. 3A-3E illustrate one or more examples of an optical module including multiple broad area diode lasers that are located at different heights from a surface mountable module base to enable vertical stacking of multiple laser beams.

FIG. 4 illustrates an example of a Dove prism.

FIGS. 5A-5B illustrate an example implementation of a high-power optical module with a single emitter and a Dove prism.

FIGS. 6A-6E illustrate one or more example implementations of an optical assembly that includes an array of optical modules with single emitter chips and Dove prisms.

FIGS. 7A-7E illustrate one or more example implementations of an optical assembly that includes an array of optical modules with single emitter chips and Dove prisms.

### DETAILED DESCRIPTION

The following detailed description of example implementations refers to the accompanying drawings. The same reference numbers in different drawings may identify the same or similar elements.

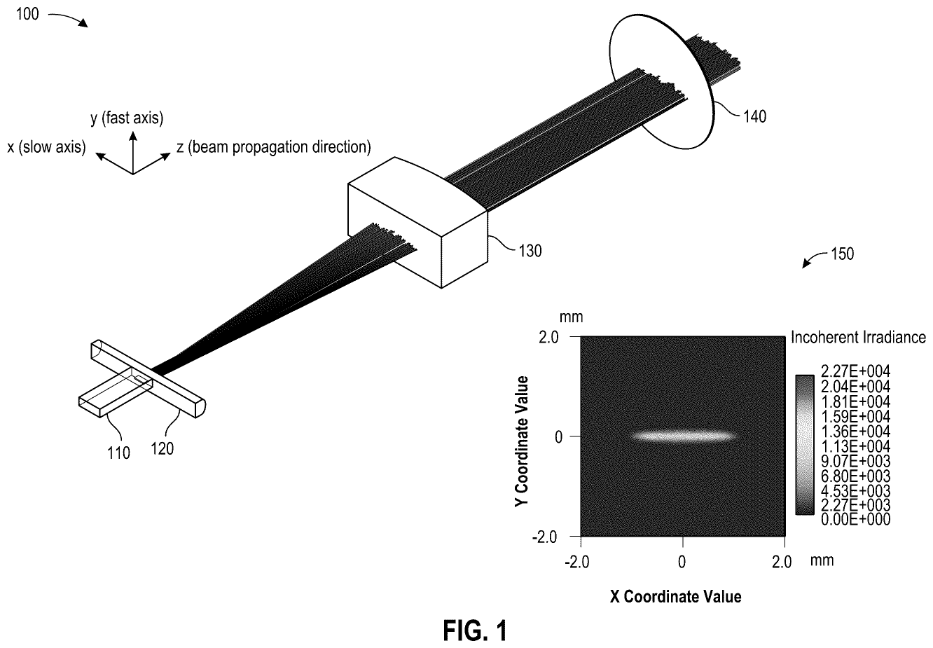

FIG. 1 illustrates an example 100 of an optical system for collimation of a single laser beam. As shown in FIG. 1, the optical system includes a diode laser 110 with a single emitter configured to emit a laser beam in a beam propagation direction (e.g., corresponding to a z-axis direction in FIG. 1). As described herein, the single emitter of the diode laser 110 has a fast axis oriented perpendicular to a top surface of the single emitter (e.g., corresponding to a y-axis direction in FIG. 1) and a slow axis oriented parallel to the top surface of the single emitter (e.g., corresponding to an x-axis direction in FIG. 1). Accordingly, as further shown in FIG. 1, the optical system includes a fast axis collimation (FAC) lens 120 arranged to collimate the laser emitted by the diode laser 110 in the fast axis direction (e.g., vertically, corresponding to the y-axis direction in FIG. 1), a slow axis collimation (SAC) lens 130 arranged to collimate the laser beam in the slow axis direction (e.g., horizontally, corresponding to the x-axis direction in FIG. 1), and a detector 140 onto which the collimated laser beam propagates. For example, as shown in FIG. 1, reference number 150 depicts an image of the single laser beam on the detector 140 after the laser beam has been collimated using the FAC lens 120 and the SAC lens 130.

In some cases, the optical system shown in FIG. 1 may be used in a high-power pump module to generate a laser beam to be coupled into a fiber (not shown in FIG. 1). For example, in a high-power optical module for a kilowatt (kW) pump, the FAC lens 120 and the SAC 130 lens are used, respectively, to collimate the laser beam output by the diode laser 110 in the vertical (fast axis) direction and the horizontal (slow axis) direction. As shown by reference number 150, after the laser beam is collimated, the collimated beam is much wider in the slow axis direction because the collimated beam has a much larger beam parameter product (BPP) in the slow axis direction relative to the fast axis direction, which is typical for a broad area diode laser.

For example, a BPP of a laser beam is generally determined based on a near field times a far field, which is typically a product of the half of an emitter width and a half divergence angle for a diode laser, and a BPP of the fiber is typically determined based on the diameter of the core of the fiber and a numerical aperture (NA), or angle, that is essentially equivalent to the far field. For example, in order to couple a laser beam into a fiber, a slow axis BPP (BPP_{SA}) needs to be less than or equal to a BPP of the fiber (BPP_{fiber}), where BPP_{SA}=(EW/2)*(Θ_{SA}/2) and BPP_{fiber}=(D/2)*(NA), where EW is the emitter width, Θ_{SA} is a slow axis full divergence angle of the diode laser, D is the diameter of the core of the fiber, and NA is the NA of the fiber. Accordingly, in order to couple a laser beam into a fiber, the following constraint must be satisfied:

$$B P {P}_{S A} = \frac{E W}{2} * \frac{{θ}_{S A}}{2} \leq {BPP}_{fiber} = \frac{D}{2} * N A$$

In high power fiber coupled diode laser modules for pump applications, the maximum permitted value of the slow axis BPP, BPP_{SA}, of a broad area laser (BAL) (e.g., a product of the half an emitter width and the half value a slow axis divergence angle), is a hard limitation for a power rating of the BAL. For example, the slow axis BPP cannot exceed the BPP of the fiber, because the laser beam would otherwise be coupled into the cladding if the slow axis BPP were to exceed the BPP of the fiber. Furthermore, because the slow axis BPP is a constant after collimation by the SAC lens 130, either the near field or the far field can be controlled, but the product of the near field times the far field cannot be changed, whereby the slow axis BPP is a hard limitation on whether the laser beam can be coupled into a fiber. For example, to achieve a design goal of making a diode laser that has a power rating as high as possible, a very large emitter width may be used, but the large emitter width would significantly increase the slow axis BPP (e.g., because the emitter width is in the numerator of the slow axis BPP calculation) such that the laser beam cannot be coupled into the fiber (e.g., because the increase in emitter width would cause the slow axis BPP to exceed the BPP of the fiber). However, a fast axis beam parameter product (BPP_{FA}) of the BAL is typically much smaller than the slow axis beam parameter product (e.g., BPP_{FA}<<BPP_{SA}). For example, in the optical system shown in FIG. 1, the slow axis is in a lateral direction, parallel to the top surface of the emitter, whereas the BAL is a single mode laser that has a much smaller BPP in a vertical (y-axis) direction, perpendicular to the top surface of the emitter. Accordingly, to increase the power of the optical module, additional laser beams may be stacked in the fast axis direction due to the fast axis having a much smaller BPP than the slow axis. For example, using a laser chip with two emitters rather than one emitter and manipulating two laser beams independently can theoretically double a chip power rating while maintaining the same BPP_{SA} for only one of the two emitters. However, using two emitters in the same diode laser chip can potentially result in a lower yield, because both emitters would need to be discarded if chip on submount testing indicates that either emitter has failed. Furthermore, using two emitters in the same diode laser chip can lead to thermal crosstalk issues, potentially reducing laser beam efficiency and/or brightness. A beam transformation system (BTS) can do the work for multi-emitter laser bars or minibars, but a BTS tends to be expensive and hard to align. Although two folding mirrors for 90° beam rotation may be less expensive than a BTS, two folding mirrors have similar problems related to optical manipulation accuracy.

As indicated above, FIG. 1 is provided as an example. Other examples may differ from what is described with regard to FIG. 1.

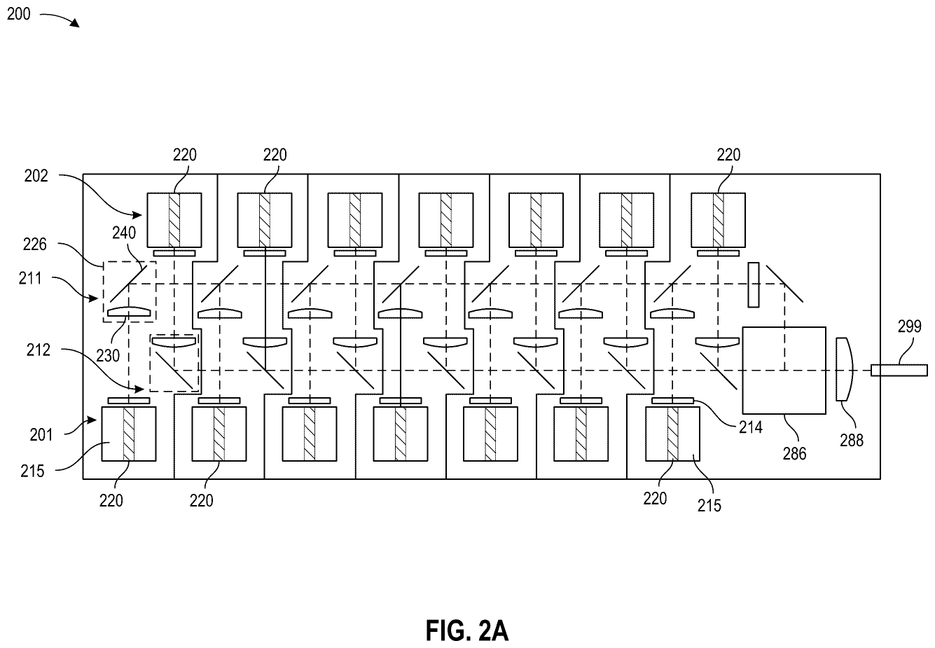

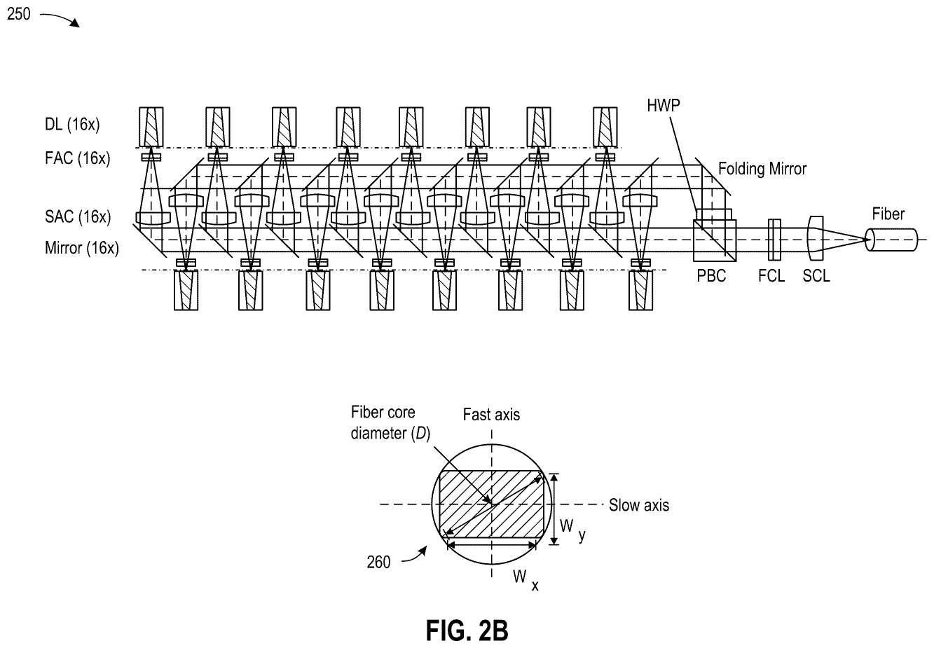

FIG. 2A illustrates an example 200 of a multi-chip package structure, and FIG. 2B illustrates an example 250 of an optical layout for a pump module based on the multi-chip package structure illustrated in FIG. 2A. For example, as described herein, the collimated beam of each BAL in a high-power optical module may be associated with an asymmetry in which the collimated beam is much wider in a slow axis than a fast axis. Accordingly, because of the asymmetry of the collimated beam of each broad area laser, high-power optical modules often stack multiple diode laser beams vertically to balance the overall BPPs in both the fast axis direction and the slow axis direction. For example, referring to FIG. 2A, example 200 depicts a high-power optical module, where each row includes a set of diode lasers that are staggered at different heights (e.g., each diode laser is not only at a different horizontal position, but only at a different height relative to the base of the package). Furthermore, the two rows of stacked laser beams are combined using a polarization beam combiner (PBC) after one row of the stacked laser beams is turned 90° by a folding mirror and their polarization direction is rotated 90° using a half-wave plate (HWP).

For example, as shown in FIG. 2A, the multi-chip package structure may include an emitter array with fourteen emitters 220 arranged in two opposing, offset banks 201, 202 that each include seven emitters 220. The two offset banks 201, 202 may be mounted on a stepped surface with mounting pads (or submounts) 215 that provide electrical contact to the emitters 220 and thermal contact between the emitters 220 and a support base that includes or acts as a heatsink. Each set of seven emitters 220 is staggered in height from lowest to highest. For example, the stepped surface may be arranged such that emitters 220 that are farthest from an output fiber 299 (e.g., the leftmost emitters 220 in FIG. 2A) are located at a greatest height relative to the support base, and such that emitters 220 that are closest to the output fiber 299 (e.g., the rightmost emitters 220 in FIG. 2A) are located at a smallest height relative to the support base.

As shown in FIG. 2A, the seven beams from each chip bank 201, 202 pass through FACs 214 that collimate the beams in planes of their respective fast axes, and the seven beams cross the opposing beams and reflect off 45° turning mirrors 240 that stack the seven beams (not shown) atop one another. For example, the multi-chip package structure 200 includes two rows 211 and 212 of beam collimating reflectors (BCRs) 226 coupled to and optically aligned with a respective emitter 220, where each BCR 226 includes a SAC 230 followed by a turning mirror 240. The two sets of stacked beams are combined at a PBC 286 (e.g., to double the brightness) and focused into an output fiber 299 using a coupling optic 288 (e.g., a coupling lens).

Referring now to FIG. 2B, example 250 depicts a top view and a ray tracing of an optical layout for a pump module based on the multi-chip package structure shown in FIG. 2A. For example, as shown in FIG. 2B, the pump module includes multiple diode lasers that are arranged in an array with two offset banks, where each diode laser is associated with one FAC, one SAC, and one turning mirror (e.g., each set of one diode laser, one FAC, and one SAC may be arranged in the manner as shown in FIG. 1). For example, in FIG. 2B, the pump module includes 16 diode lasers, 16 FACs, 16 SACs, and 16 mirrors, which create two sets of eight beams that are stacked and combined using a folding mirror, an HWP, and a PBC. However, the pump module may include other quantities of diode lasers, FACs, SACs, and mirrors to create a different (larger or smaller) number of beams that can be stacked and combined using the folding mirror, the HWP, and the PBC. For example, the pump module may include 32 diode lasers, 32 FACs, 32 SACs, and 32 mirrors that are arranged in two banks of sixteen to create two sets of sixteen beams that are stacked and combined using the folding mirror, the HWP, and the PBC. In any case, as shown in FIG. 2B, the stacked beams may then be focused into an output fiber using a fast axis coupling lens (FCL) and a slow axis coupling lens (SCL). For example, FIG. 2B illustrates a slow axis ray trace in a top view, where the various beams emitted by the diode lasers are each collimated by a respective FAC and a respective SAC before reflecting off a respective mirror and being coupled into the fiber by the FCL and the SCL.

As further shown in FIG. 2B, reference number 260 depicts a spot diagram of beams on a tip of the fiber, where the spot diagram corresponds to all of the sixteen laser beams after focusing and overlapping. As shown by reference number 260, even after the laser beams emitted by the sixteen diode lasers are focused and stacked in the fast axis direction, the spot diagram is not a perfect square, whereby the overall BPP_{nFA} is still smaller than the BPP_{SA} of one laser diode. In this case, to couple n beams into the fiber, where n is an integer greater than one (1), the following condition needs to be satisfied:

$${( B P {P}_{S A} )}^{2} + {( B P {P}_{n F A} )}^{2} \leq {( {BPP}_{fiber} )}^{2} ,$$

where a value of BPP_{nFA} is approximately equal to n/γ*BPP_{FA}, where γ is a fill factor of the beam stacking (e.g., a measure of the stacked beams filling the area of the fiber core, where a worse or lower value for the fill factor reduces the number of lasers that can be stacked and coupled into the fiber). As described above, one diode laser may generally be coupled into a fiber in cases where the slow axis BPP is less than the BPP of the fiber. However, in cases where multiple diode lasers are stacked in the fast axis direction, the total fast axis BPP increases, and the squares of the BPP_{SA} and the BPP_{nFA} need to satisfy the above condition.

As indicated above, FIGS. 2A-2B are provided as an example. Other examples may differ from what is described with regard to FIGS. 2A-2B.

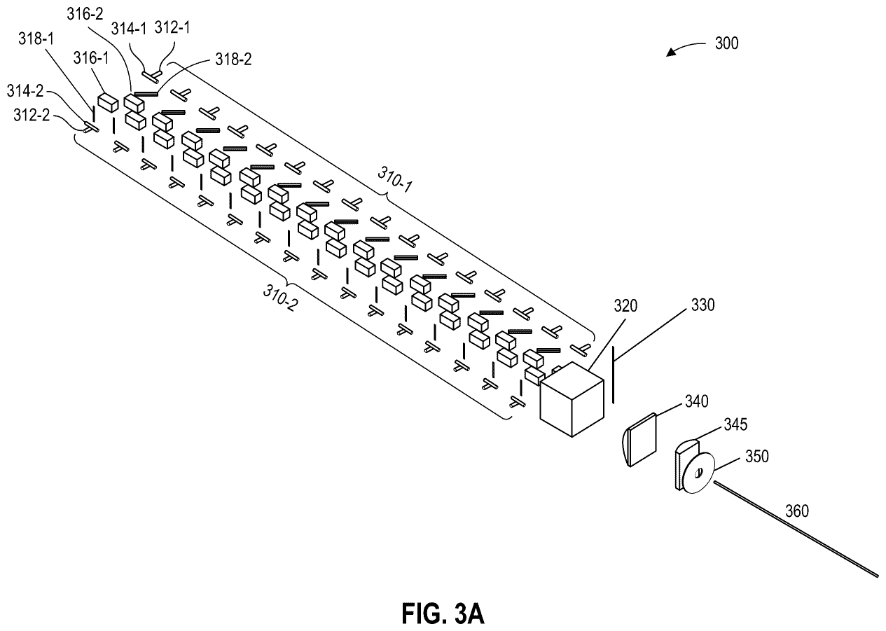

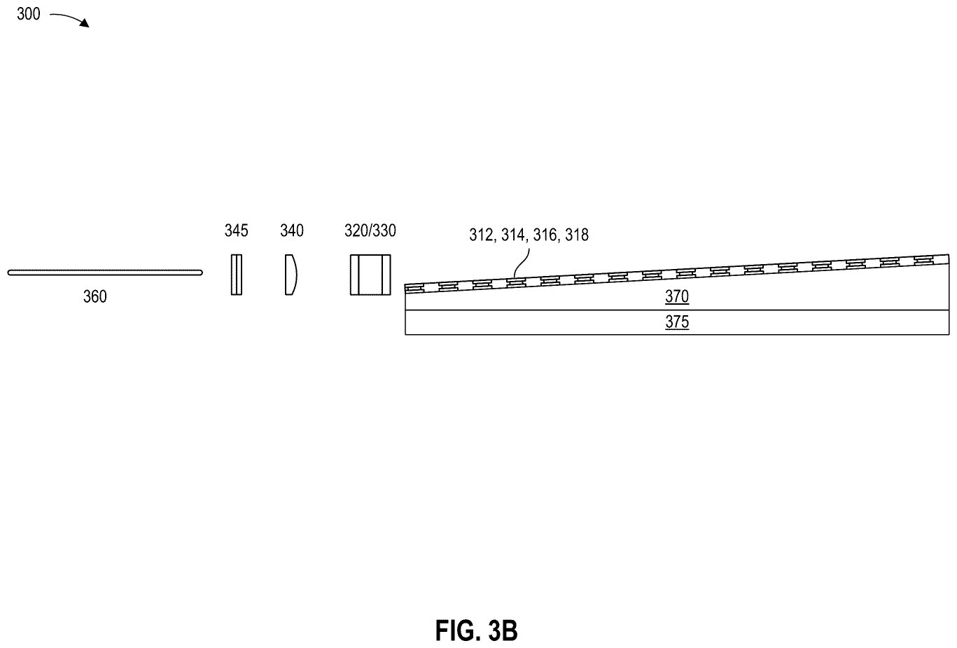

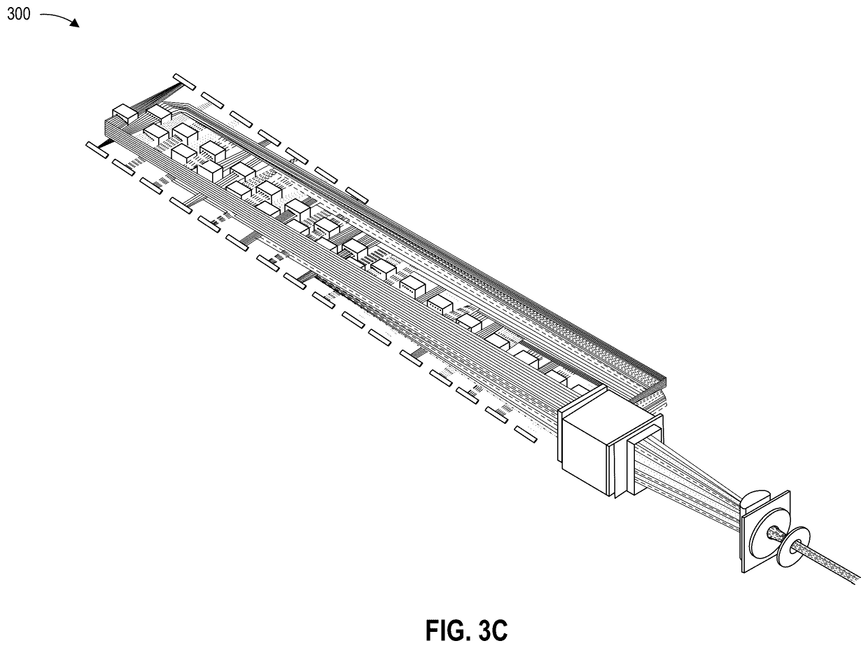

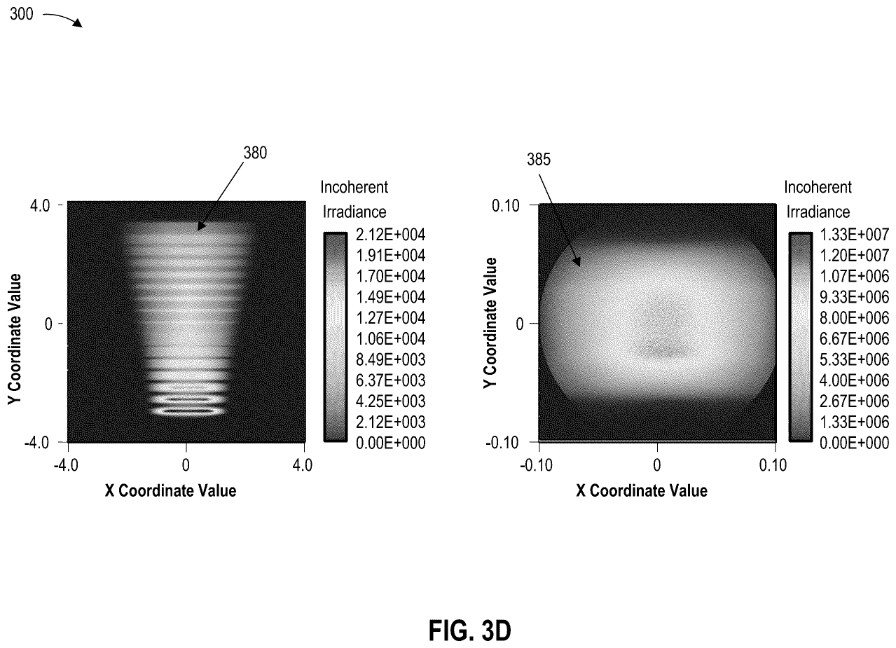

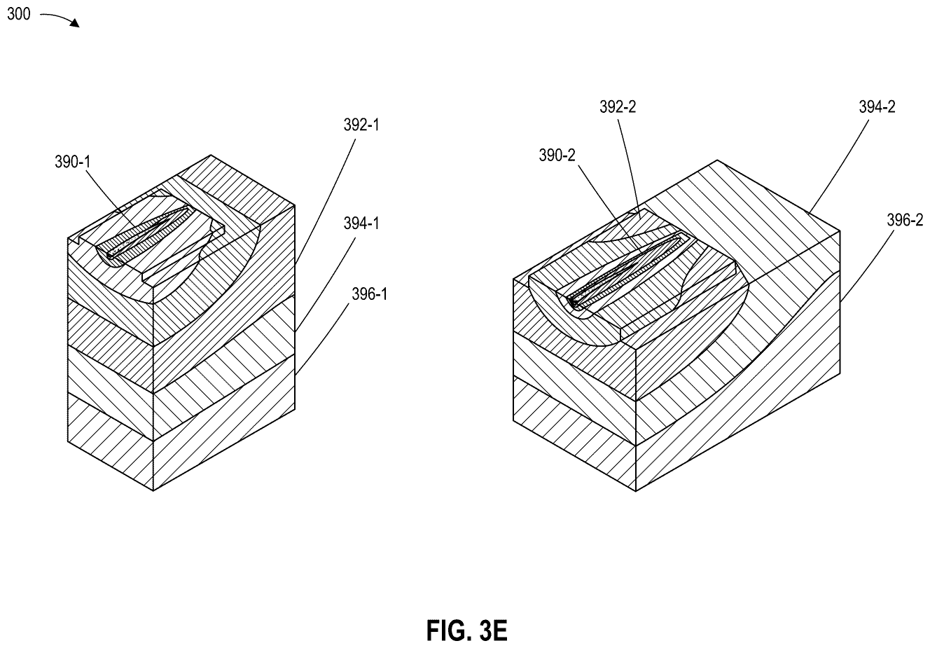

FIGS. 3A-3E illustrate an example 300 of a high-power optical module that includes various broad area diode lasers that are staggered in two rows. For example, FIG. 3A illustrates an isometric view and FIG. 3B illustrates a side view of a high-power optical module that includes various broad area diode lasers that are staggered in two rows. As shown, the high-power optical module includes a first set of sixteen diode lasers 312-1 and sixteen corresponding FAC lenses 314-1, SAC lenses 316-1, and folding mirrors 318-1 arranged in a first band 310-1, and a second set of sixteen diode lasers 312-2 and sixteen corresponding FAC lenses 314-2, SAC lenses 316-2, and folding mirrors 318-2 arranged in a second band 310-2. In addition, the high-power optical module includes a PBC 320, a large folding mirror 330, an FCL 340, an SCL 345, and an NA filter 350 that act together to couple the 32 total laser beams into a fiber 360.

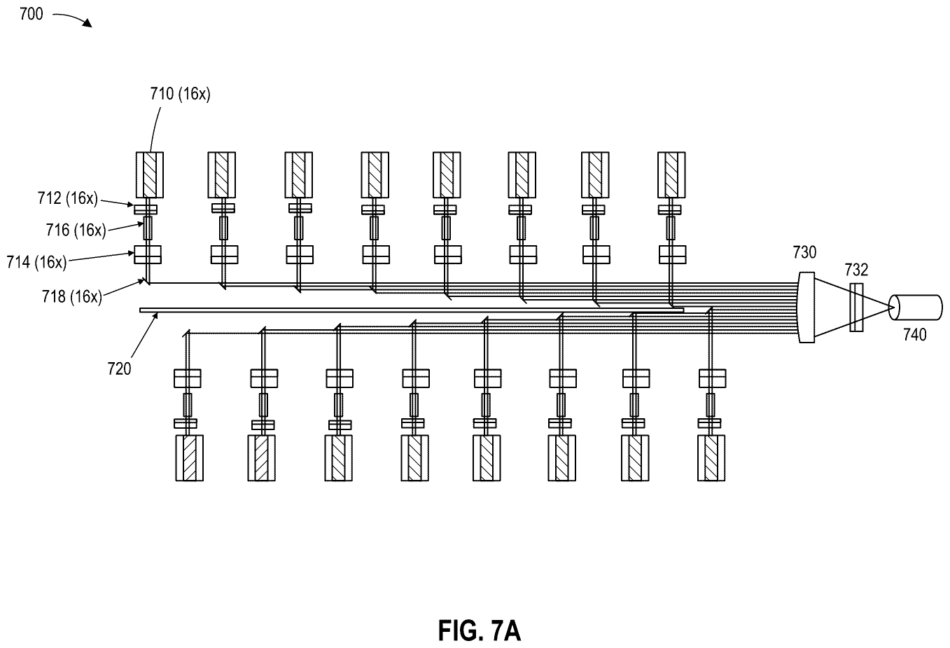

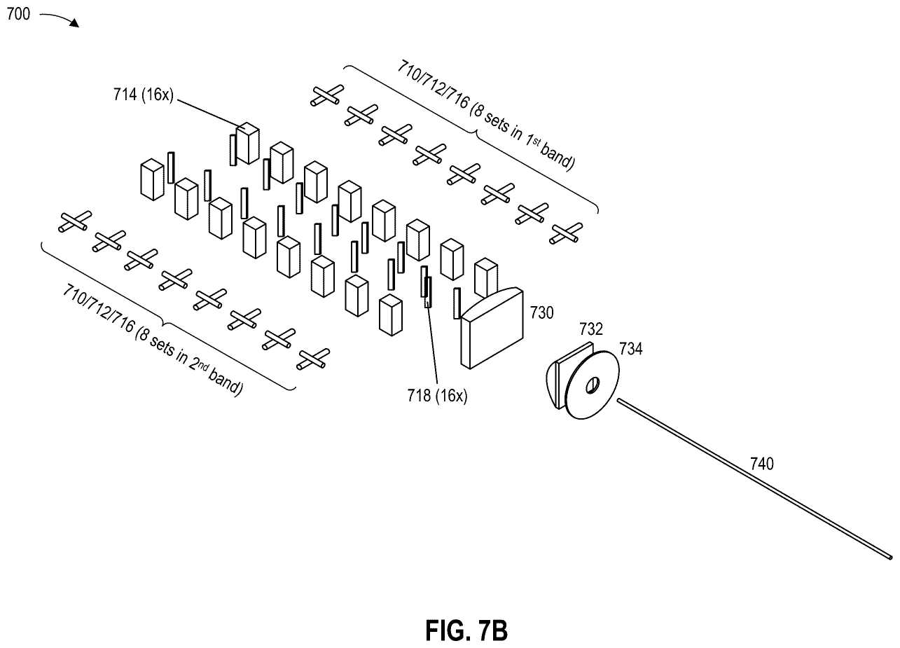

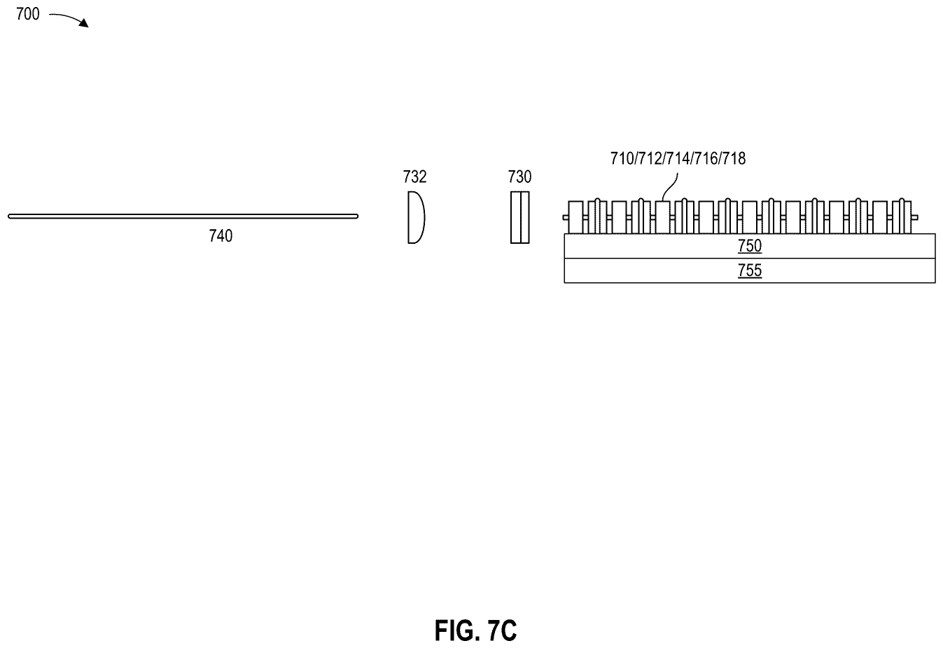

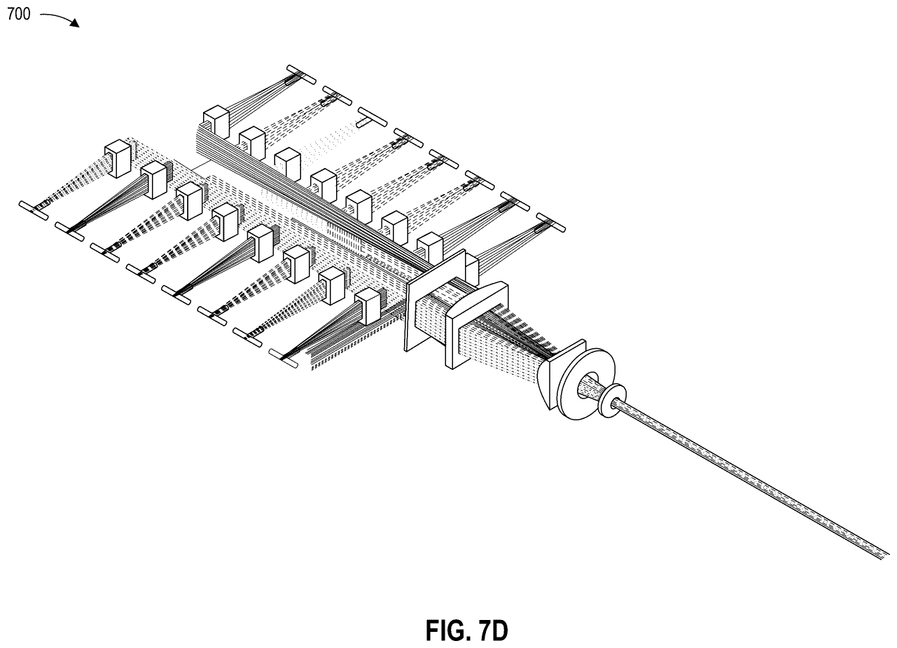

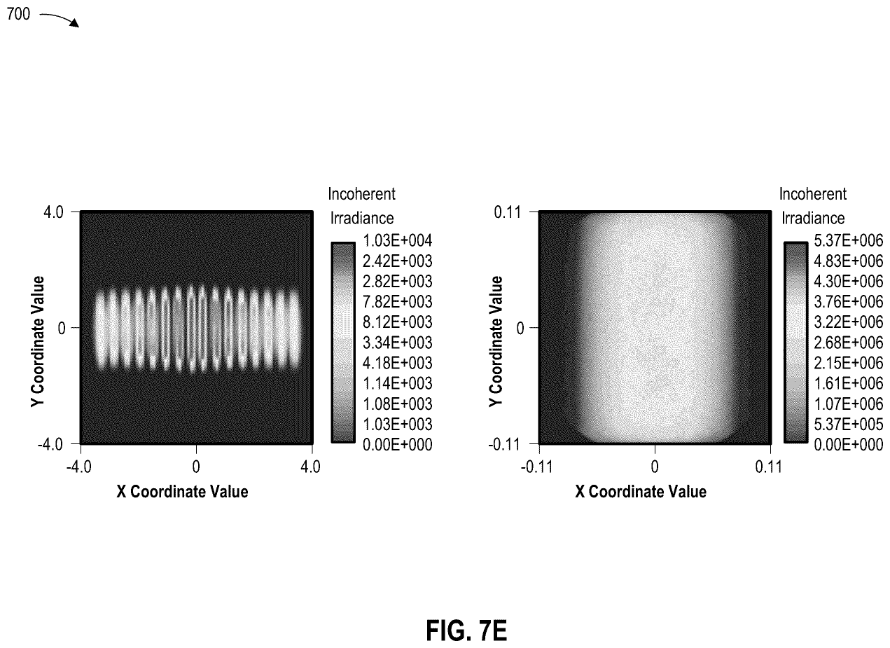

For the vertical beam stacking, the broad area diode lasers 312 need to be placed at different heights from a surface mountable base 370 of the optical module. For example, as shown in FIG. 3A, each broad area diode laser 312 may be associated with a respective FAC lens 314, a respective SAC lens 316, and a respective folding mirror 318, which may be located at a different height from every other diode laser 312 in the same band 310 and the same or a similar height as a diode laser 312 in the opposite band 310. As a result, the vertical beam stacking poses challenges such as non-uniform heat sinking for different diode lasers 312, because the variation in height results in non-uniform thermal resistance and/or different junction temperatures among the diode lasers 312 (e.g., due to the variation in distance from the surface mountable base 370 that is provided over a heat sink 375). The issue becomes worse when more diode lasers 312 are staggered for even higher power and/or brightness per optical module. As an example, FIG. 3A and FIG. 3B respectively depict the isometric and side views of a key component layout for such a high-power optical module. As shown in FIG. 3B, the diode lasers are located at different heights in the vertical y-axis direction. Accordingly, different diode lasers have different thermal resistances and/or junction temperatures despite the different diode lasers 312 being surface mounted over the same heat sink 375. The non-sequential ray tracing of the optical module is shown in FIG. 3C, vertical beam stacking of the collimated laser beam is shown on the left side of FIG. 3D, and a spot diagram at a front fiber tip surface is shown on the right side of FIG. 3D. Additionally, another issue associated with the staggered arrangement of diode lasers 312 relates to residual divergence angles after beam collimation. As shown by reference number 380 in FIG. 3D, the laser beams that are furthest from the fiber tip (e.g., corresponding to the laser beams emitted by the diode lasers 312 that are furthest from the fiber tip and at the highest height relative to the surface mountable base 370) become wider and less focused after such laser beams propagate a longer distance, which increases the difficulty of coupling such laser beams into the fiber tip relative to the laser beams that are closer to the fiber tip and at lower heights relative to the surface mountable base 370. Also, this issue is reflected by the relatively low quality of the spot diagram as depicted by reference number 385 in FIG. 3D, which shows that the spot diagram does not have sharp rectangular edges. Mitigation of the issue related to the length of the optical path length are discussed in further detail below with reference to FIG. 7A-7E, where horizontal beam stacking is enabled by Dove prisms without a PBC.

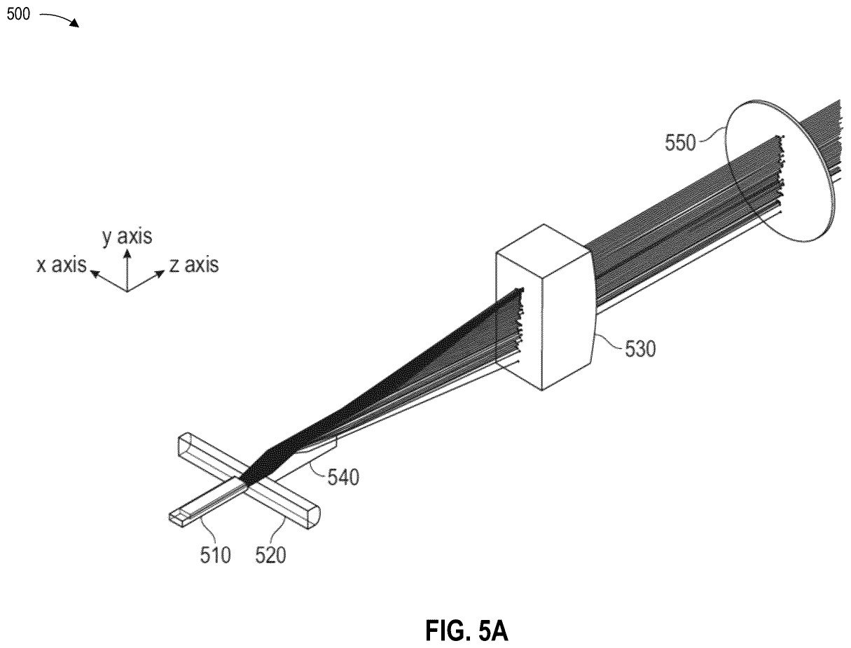

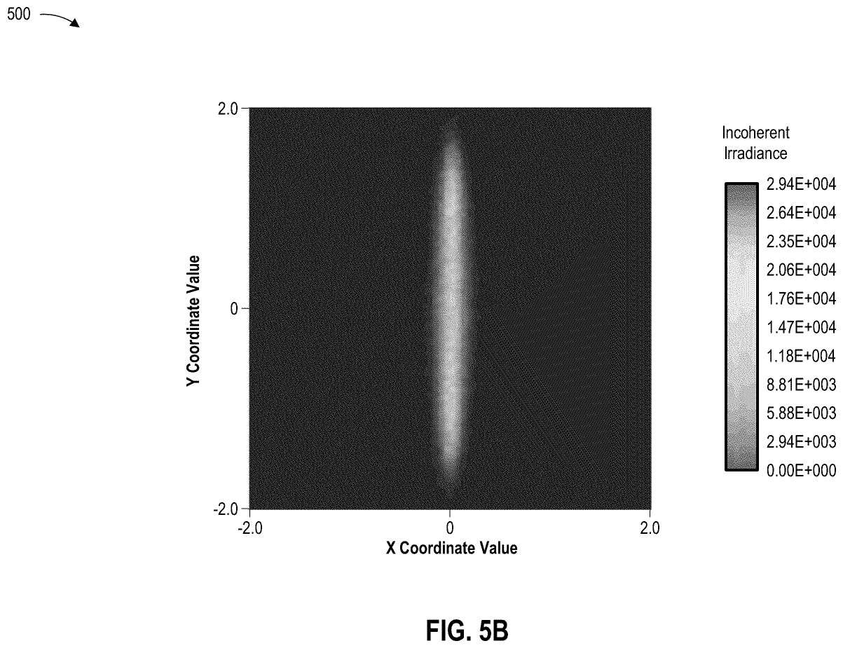

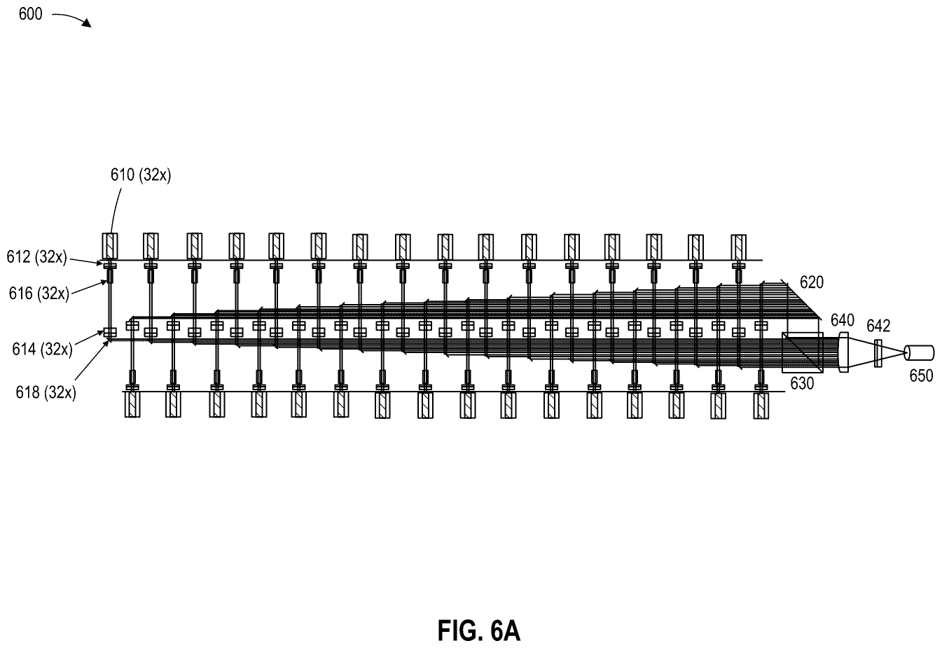

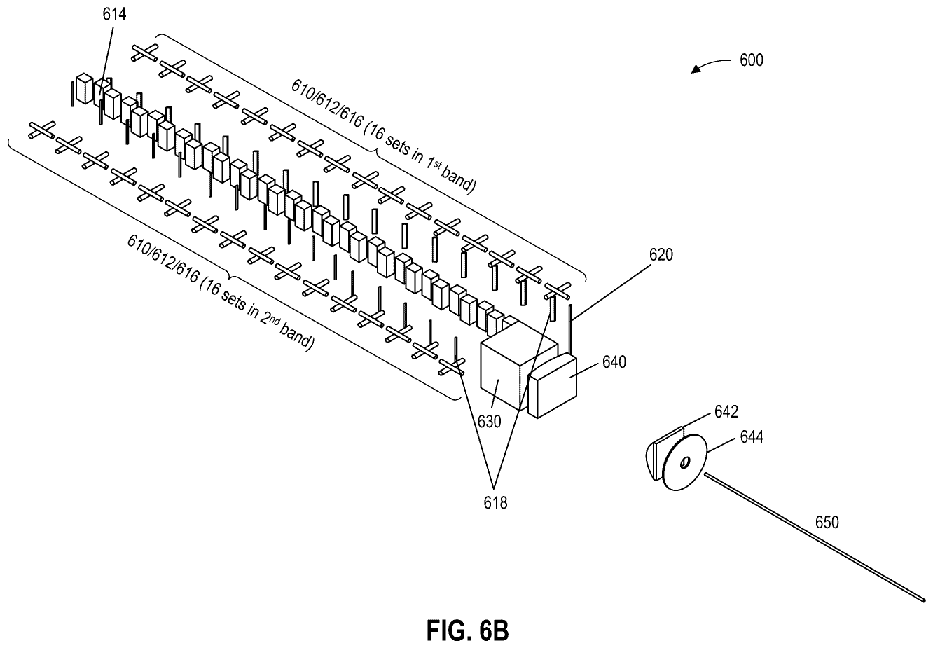

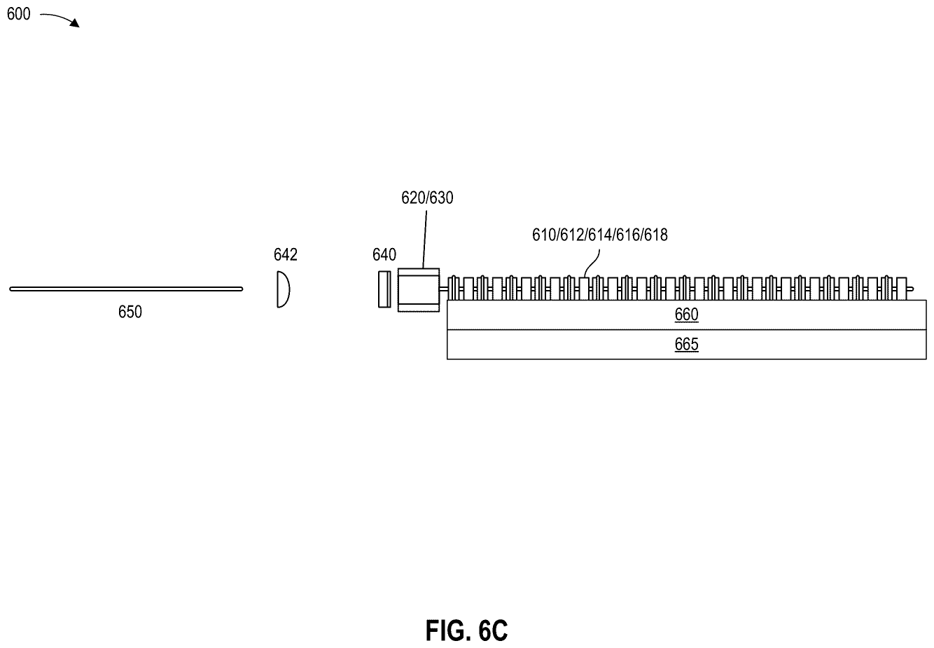

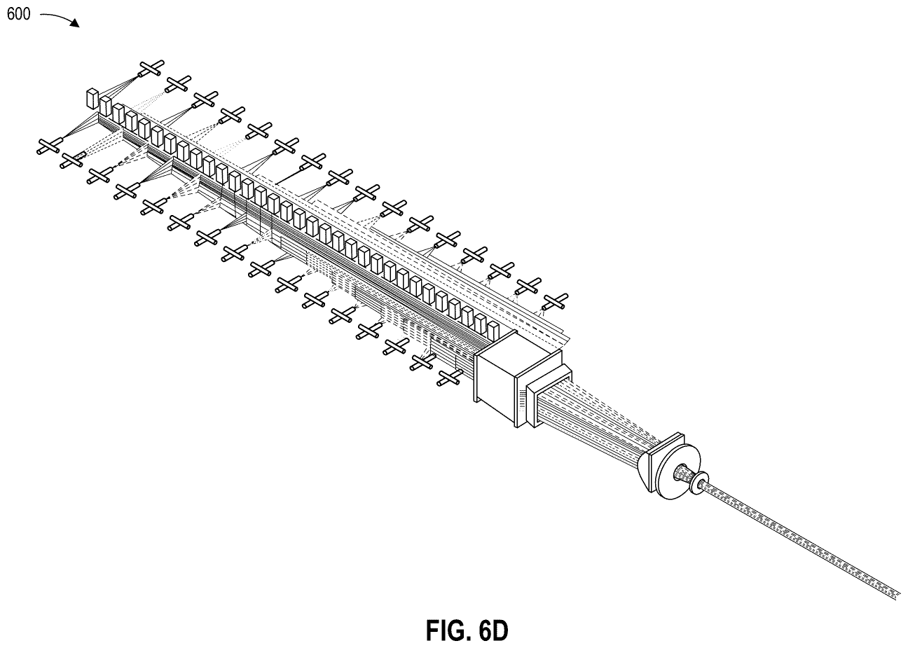

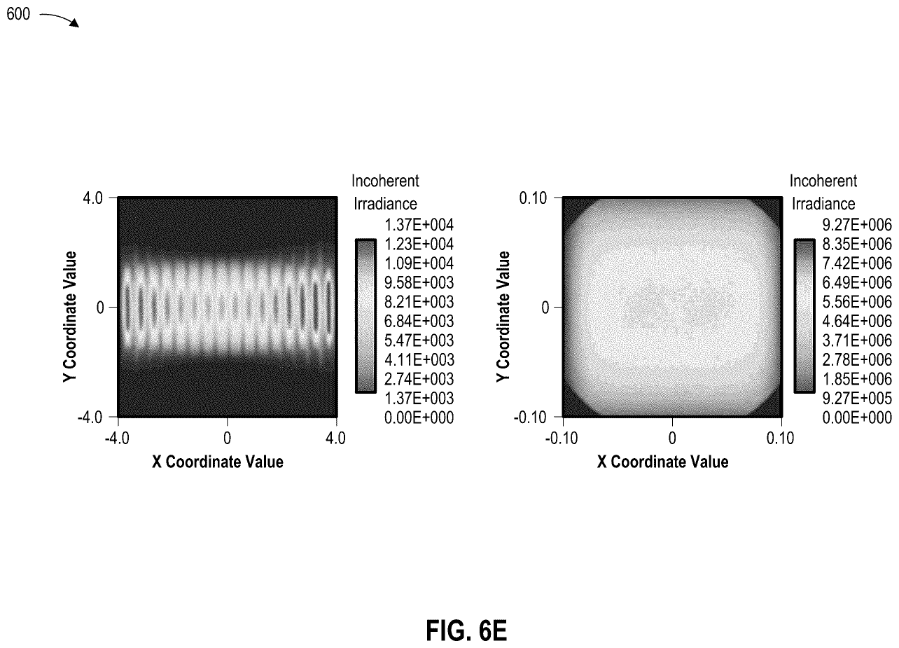

Furthermore, FIG. 3E illustrates the non-uniform heat sinking for staggered diode lasers. For example, thermal modeling of a higher hotter channel is shown on the left side of FIG. 3E, and thermal modeling of a lower cooler channel is shown on the right side of FIG. 3E. For example, the higher hotter channel shown on the left side of FIG. 3E may correspond to a diode laser 312 that is arranged relatively farther away from the surface mountable base 370, and therefore farther away from the heatsink 375 (e.g., a rightmost diode laser 312 in the side view shown in FIG. 3B), resulting in a higher thermal resistance. In addition, the lower cooler channel shown on the right side of FIG. 3E may correspond to a diode laser 312 that is arranged relatively closer to the surface mountable base 370, and therefore closer to the heatsink 375 (e.g., a leftmost diode laser 312 in the side view shown in FIG. 3B), resulting in a lower thermal resistance. As shown in FIG. 3E, the higher hotter channel has thermal regions 390-1, 392-1, 394-1, 396-1, where thermal region 390-1 is a hottest region (closest to the emitter that generates heat) and thermal region 396-1 is a coolest region (closest to the surface mountable base 370 provided over the heat sink 375). Similarly, the lower cooler channel has thermal regions 390-2, 392-2, 394-2, 396-2, where thermal region 390-2 is a hottest region (closest to the emitter that generates heat) and thermal region 396-2 is a coolest region (closest to the surface mountable base 370 provided over the heat sink 375). As shown, the cooler regions 394-2 and 396-2 of the lower channel are much larger than the cooler regions 394-1 and 396-1 of the higher channel, and the hotter regions 390-2 and 392-2 of the lower channel are much more contained relative to the hotter regions 390-1 and 392-1 of the higher channel. For example, using a typical 400 micrometer (μm) vertical step as an estimation, FIG. 3E shows that the highest channels have about 30% more thermal resistance than the lowest channels. The resulting non-uniform cooling can make the higher diode laser channels more than 10° Celsius (C) hotter in junction temperature than the lower channels, which broadens the spectra of the pump modules in addition to making the hotter channels less efficient and more prone to failure during long-term operation. Accordingly, to resolve the non-uniform cooling associated with the vertical beam stacking, some implementations described in further detail herein with reference to FIGS. 5A-5B, FIGS. 6A-6E, and/or FIGS. 7A-7E relate to a high-power optical module in which a Dove prism is inserted between a FAC lens and a SAC lens to rotate each laser beam by 90°. In this way, the rotated laser beams can be stacked in a horizontal direction (parallel to the top surfaces of the emitters), which allows the various diode lasers to be located at the same height and thereby address the non-uniform thermal issues. Furthermore, as described in further detail herein with respect to FIGS. 7A-7E, inserting a Dove prism between the FAC lens and the SAC lens to rotate each laser beam by 90° allows a smaller number of diode lasers to be arranged in two rows without using a PBC, which can reduce the optical path length for the diode lasers that are farthest from the fiber tip and thereby improve quality of the stacked laser beams.

As indicated above, FIGS. 3A-3E are provided as an example. Other examples may differ from what is described with regard to FIGS. 3A-3E.

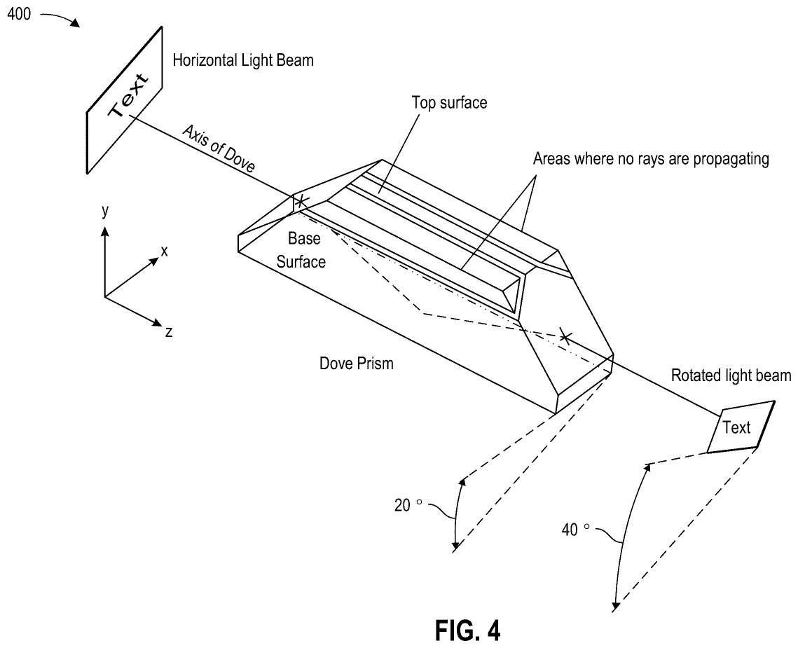

FIG. 4 illustrates an example of a Dove prism, which is a prism that can be used to rotate a laser beam. For example, the Dove prism may be shaped from a truncated right-angle prism and has two sloped faces (e.g., two tilted planes at a base angle between a top surface and a bottom surface), where a light beam that travels parallel to a longitudinal axis of the Dove prism and enters one of the sloped faces of the Dove prism experiences total internal reflection from the inside of the longest (bottom) surface and emerges from the opposite sloped face. Accordingly, a beam that passes through the Dove prism is rotated.

Rotating the Dove prism about the longitudinal axis rotates the image at twice the rate of the rotation of the Dove prism (e.g., a 20° rotation of the Dove prism results in a 40° rotated image). Due to the high incidence angle, the light reflecting from the bottom face undergoes total internal reflection, even if the propagation axis of the light and the longitudinal axis of the Dove prism are not exactly parallel. Accordingly, in a Dove prism, the magnitude of the internal transmission is limited only by absorption.

As indicated above, FIG. 4 is provided as an example. Other examples may differ from what is described with regard to FIG. 4.

FIGS. 5A-5B illustrate an example implementation 500 of a high-power optical module with a single emitter and a Dove prism. As shown in FIG. 5A, the optical module may include a diode laser 510 with a single emitter configured to emit a laser beam in a beam propagation direction, a FAC lens 520, a SAC lens 530, a Dove prism 540, and a detector 550 onto which the collimated beam propagates. Furthermore, FIG. 5B illustrates an example of the collimated laser beam striking onto the detector 550, after the laser beam has passed through the FAC lens 520, the Dove prism 540, and the SAC lens 530 and rotated 90° relative to the directions that the laser beam is emitted by the emitter of the diode laser 510. For example, in some implementations, the Dove prism 540 may be arranged between the FAC lens 520 and the SAC lens 530 associated with each diode laser 510 in a high-power optical module in order to rotate the laser beam emitted by the corresponding diode laser by 90° and thereby resolve the non-uniform cooling associated with vertical stacking. For example, because the laser beams are rotated 90°, various laser beams can be stacked in a horizontal direction (e.g., parallel to the top surface of the diode laser 510), whereby multiple diode lasers 510 in a high-power optical module can be arranged at the same height relative to (e.g., equidistant from) a heat sink to provide a more uniform thermal resistance and/or junction temperature. As a result, a state of the laser beam after the beam rotation and collimation may be as shown in FIG. 5B, whereby the 90° beam rotation by the Dove prism 540 permits horizontal beam stacking, rather than the vertical beam stacking that results in non-uniform cooling.

Accordingly, as described herein, a high-power optical module may generally include a diode laser 510 that includes a single emitter configured to emit a laser beam in a beam propagation direction (e.g., the z-axis direction in FIG. 5A). In some implementations, the single emitter has a fast axis oriented perpendicular to a top surface of the single emitter (e.g., in the y-axis direction in FIG. 5A), and a slow axis oriented parallel to the top surface of the single emitter (e.g., in the x-axis direction in FIG. 5A). Furthermore, the high-power optical module may include a FAC lens 520 arranged to collimate the laser beam in a perpendicular direction relative to the top surface of the single emitter, a SAC lens 530, arranged after the FAC lens, to collimate the laser beam in a parallel direction relative to the top surface of the single emitter, and a Dove prism 540 arranged between the FAC lens 520 and the SAC lens 530. As described herein, the Dove prism 540 includes an axis that is rotated 45° relative to the single emitter such that an orientation of a fast axis and an orientation of a slow axis of the laser beam are rotated 90° after the laser beam passes through the Dove prism 540 (e.g., such that the orientation of the fast axis of the laser beam is parallel to the top surface of the single emitter and the orientation of the slow axis of the laser beam is perpendicular relative to the top surface of the single emitter after the laser beam passes through the Dove prism 540). Additionally, or alternatively, the axis of the Dove prism 540 may be rotated at an angle that is within a threshold of 45° (e.g., between 40-) 50° relative to the single emitter such that the orientation of the fast axis and the orientation of the slow axis of the laser beam are rotated at an angle that is within a threshold of 90° after the laser beam passes through the Dove prism 540 (e.g., such that the orientation of the fast axis of the laser beam is substantially parallel to the top surface of the single emitter and the orientation of the slow axis of the laser beam is substantially perpendicular relative to the top surface of the single emitter after the laser beam passes through the Dove prism 540). For example, in some implementations, the Dove prism 540 is rotated 45 degrees relative to the single emitter such that the Dove prism 540 rotates the laser beam by 90 degrees, which results in the slow axis and the fast axis swapping orientations (e.g., relative to a plane defined by a chip, or a package base on which the chip is resting or mounted) after passing through the Dove prism 540, thereby enabling horizontal beam stacking. Furthermore, in some implementations, a center of the Dove prism 540 is aligned with a center of the single emitter (e.g., in the fast axis and slow axis directions). Accordingly, as described herein with reference to FIGS. 6A-6E and FIGS. 7A-7E, the diode laser 510, the FAC lens 520, the SAC lens 530, and the Dove prism 540 may be mounted on a surface mountable base (e.g., in one or more machined grooves formed in the surface mountable base, or using a 45° cut surface along one of four parallel edges of the Dove prism 540). Furthermore, when used with a PBC (e.g., as in FIGS. 6A-6E), a base angle of the Dove prism 540 may exceed 45° (e.g., because a 57.5° base angle can mitigate polarization impurity effects by ˜50%, while a 70° base angle can mitigate the effect by more than 90%). Alternatively, when the PBC is omitted (e.g., as in FIGS. 7A-7E), fewer diode lasers can be used and arranged in opposing rows to reduce the optical path length associated with the diode lasers located farthest from the fiber, which improves beam quality for the horizontally stacked laser beams and facilitates easier coupling into the fiber.

As indicated above, FIGS. 5A-5B are provided as an example. Other examples may differ from what is described with regard to FIGS. 5A-5B.

FIGS. 6A-6E illustrate one or more example implementations 600 of an optical assembly that includes an array of optical modules with single emitter chips and Dove prisms. For example, FIG. 6A illustrates a top view, FIG. 6B illustrates an isometric view, and FIG. 6C illustrates a side view of a high-power optical module that includes a first set of sixteen diode lasers 610 and sixteen corresponding FAC lenses 612, SAC lenses 614, Dove prisms 616, and folding mirrors 618 arranged in a first band, a second set of sixteen diode lasers 610 and sixteen corresponding FAC lenses 612, SAC lenses 614, Dove prisms 616, and folding mirrors 618 arranged in a second band, a large folding mirror 620, a PBC 630, an FCL 640, an SCL 642, and an NA filter 644 that act together to couple various laser beams into a fiber 650. In general, other than the insertion of a Dove prism 616 between the FAC lens 612 and the SAC lens 614 associated with each diode laser 610, the architecture of the optical assembly is similar to the architecture of the optical assembly described above with reference to FIGS. 3A-3C.

More particularly, as shown in FIGS. 6A-6D, the optical assembly includes the large folding mirror 620, the PBC 630, the FCL 640, and the SCL 642 arranged to couple multiple laser beams into the optical fiber 650. Furthermore, the optical assembly includes an array that includes multiple optical devices arranged in a first row and a second row to generate the multiple laser beams. For example, as shown, each row includes sixteen optical devices, where the multiple optical devices each include a diode laser 610 that includes a single emitter configured to emit a laser beam in a beam propagation direction, a FAC lens 612 arranged to collimate the laser beam, a SAC lens 614, arranged after the FAC lens 612, to collimate the laser beam, a Dove prism 616 arranged between the FAC lens 612 and the SAC lens 614, and a mirror 618, arranged after the SAC lens 614, to direct the laser beam toward the PBC 630, the FCL 640, and the SCL 642. In some implementations, as described herein, the Dove prism 616 includes an axis that is rotated 45° relative to the single emitter such that an orientation of a fast axis and an orientation of a slow axis of the laser beam are rotated 90° after the laser beam passes through the Dove prism 616.

As shown in FIG. 6C, the 90° rotation of the laser beams and the collimation of the 90° rotated laser beams allows the diode lasers 610 to be located at the same height in the vertical y-axis direction. Accordingly, the multiple optical devices that each include a diode laser 610, FAC lens 612, SAC lens 614, Dove prism 616, and folding mirror 618, each of which are mounted at the same height relative to a surface mountable base 660 and equidistant from a heatsink 665 provided under the surface mountable base 660. As such, because the diode laser 610, FAC lens 612, SAC lens 614, Dove prism 616, and folding mirror 618 associated with optical device is equidistant from the heatsink 665, a thermal resistance and a junction temperature is more uniform (e.g., equal, or within a threshold of being equal) for each of the multiple optical devices relative to a design in which the various optical devices are staggered at different heights. The non-sequential ray tracing of the high-power optical module is shown in FIG. 6D, a horizontal beam stacking of the collimated laser beams is shown on the left side of FIG. 6E, and a spot diagram at the front fiber tip surface is shown on the right side of FIG. 6E. In this way, utilizing Dove prisms for 90° rotation to enable horizontal laser beam stacking (e.g., in a direction parallel to a top surface of the single emitter of each diode laser 610), thermal management may be more uniform among all diode laser channels, because the diode lasers 612 are arranged at the same height relative to the surface mountable base 660 and the heatsink 665. Furthermore, all of the optical components of the high-power optical module, including the Dove prisms 616 inserted between the FAC lens 612 and the SAC lens 614 associated with each diode laser, are surface mountable. For example, the Dove prisms 616 may each be rotated 45° (for 90° beam rotation), and can be either mounted in pre-machined V-shaped grooves formed in the surface mountable base 660, or by a 45°-cut surface along one of the four parallel edges that interfaces with the surface mountable base 660.

Additionally, or alternatively, a Dove prism 616 with a base angle larger than 45° may be used to mitigate an effect whereby a Dove prism 616 cannot maintain 100% linearity for an ideally polarized laser beam along with beam rotation. Thus, after the 90° beam rotation, the polarization purity is degraded, which can make the PBC 630 less efficient than without such Dove prisms 616. However, a Dove prism 616 with a larger base angle can mitigate such effect. As an example, compared to the 45° base angle, a 57.5° base angle for the Dove prism 616 can mitigate the polarization impurity effect by about 50%, while a 70° base angle can mitigate the polarization impurity effect by more than 90%. Thus, if a PBC 630 is used as shown in FIGS. 6A-6D, a Dove prism 616 with a base angle larger than 45° may be used.

As indicated above, FIGS. 6A-6E are provided as an example. Other examples may differ from what is described with regard to FIGS. 6A-6E.

FIGS. 7A-7E illustrate one or more example implementations 700 of an optical assembly that includes an array of optical modules with single emitter chips and Dove prisms, while omitting a PBC. For example, FIG. 7A illustrates a top view, FIG. 7B illustrates an isometric view, and FIG. 7C illustrates a side view of a high-power optical module that includes a first set of eight diode lasers 710 and eight corresponding FAC lenses 712, SAC lenses 714, Dove prisms 716, and folding mirrors 718 arranged in a first band, a second set of eight diode lasers 710 and eight corresponding FAC lenses 712, SAC lenses 714, Dove prisms 716, and folding mirrors 718 arranged in a second band, an FCL 730, an SCL 732, and an NA filter 734 that act together to couple various laser beams into a fiber 740. In general, other than the insertion of a Dove prism 716 between the FAC lens 712 and the SAC lens 714 associated with each diode laser 712, the architecture of the optical assembly is different from the architecture of the optical assembly described above with reference to FIGS. 3A-3C and/or FIG. 6A-6D in that the sixteen diode lasers are arranged in two rows, such that the farthest diode lasers 710 are much closer to the fiber tip. In this way, because the optical path length between the farthest diode lasers 710 and the fiber tip is reduced relative to a design where each row includes sixteen diode lasers, coupling the sixteen laser beams into the fiber core is much easier. Furthermore, as shown in FIG. 7A, the high-power optical module may include an optional wall structure 720 to separate the first and second band.

More particularly, as shown in FIGS. 7A-7E, the optical assembly includes the FCL 730, and the SCL 732 arranged to couple multiple laser beams into the optical fiber 740. Furthermore, the optical assembly includes an array that includes multiple optical devices arranged in a first row and a second row to generate the multiple laser beams. For example, as shown, each row includes eight optical devices, where the multiple optical devices each include a diode laser 710 that includes a single emitter configured to emit a laser beam in a beam propagation direction, a FAC lens 712 arranged to collimate the laser beam, a SAC lens 714, arranged after the FAC lens 712, to collimate the laser beam, a Dove prism 716 arranged between the FAC lens 712 and the SAC lens 714, and a mirror 718, arranged after the SAC lens 714, to direct the laser beam toward the FCL 730 and the SCL 732. In some implementations, as described herein, the Dove prism 716 includes an axis that is rotated 45° relative to the single emitter of each diode laser 710 such that an orientation of a fast axis and an orientation of a slow axis of the laser beam are rotated 90° after the laser beam passes through the Dove prism 716.

As shown in FIG. 7C, the 90° rotation of the laser beams and the collimation of the 90° rotated laser beams allows the diode lasers 710 to be located at the same height in the vertical y-axis direction. The non-sequential ray tracing of the high-power optical module is shown in FIG. 7D, a horizontal beam stacking of the collimated laser beams is shown on the left side of FIG. 7E, and a spot diagram at the front fiber tip surface is shown on the right side of FIG. 7E. In this way, by utilizing the Dove prisms 716 for 90° rotation to enable horizontal laser beam stacking, thermal management may be more uniform among all diode laser channels, because the diode lasers 710 are arranged at the same height relative to surface mountable base 750 provided over a heat sink 755. Furthermore, all of the optical components of the high-power optical module, including the Dove prisms 716 inserted between the FAC lens 712 and the SAC lens 714 associated with each diode laser 710, are surface mountable. For example, the Dove prisms 716 may each be rotated 45° (for 90° beam rotation and a smaller length to aperture ratio), and can be mounted in pre-machined V-shaped grooves or by a 45°-cut surface along one of the four parallel edges.

As indicated above, FIGS. 7A-7E are provided as an example. Other examples may differ from what is described with regard to FIGS. 7A-7E.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical module, comprising:
a diode laser that includes a single emitter configured to emit a laser beam in a beam propagation direction,
wherein the single emitter has a fast axis oriented perpendicular to a top surface of the single emitter and a slow axis oriented parallel to the top surface of the single emitter;
a fast axis collimation (FAC) lens arranged to collimate the laser beam in the fast axis;
a slow axis collimation (SAC) lens, arranged after the FAC lens, to collimate the laser beam in the slow axis; and
a Dove prism arranged between the FAC lens and the SAC lens,
wherein the Dove prism includes an axis that is rotated 45 degrees relative to the single emitter such that an orientation of the fast axis and an orientation of the slow axis of the laser beam are rotated 90 degrees after the laser beam passes through the Dove prism.

2. The optical module of claim 1, wherein the orientation of the fast axis of the laser beam is parallel to the top surface of the single emitter and the orientation of the slow axis of the laser beam is perpendicular relative to the top surface of the single emitter after the laser beam passes through the Dove prism.

3. The optical module of claim 1, wherein the laser beam is wider in a first direction perpendicular to the top surface of the single emitter than a second direction parallel to the top surface of the single emitter after passing through the Dove prism.

4. The optical module of claim 1, wherein a center of the Dove prism is aligned with a center of the single emitter.

5. The optical module of claim 1, further comprising:
a surface mountable base, wherein the diode laser, the FAC lens, the SAC lens, and the Dove prism are mounted on the surface mountable base.

6. The optical module of claim 1, wherein the Dove prism is mounted in one or more machined grooves formed in a surface mountable base.

7. The optical module of claim 1, wherein the Dove prism includes a 45 degree cut surface along one of four parallel edges.

8. The optical module of claim 1, wherein a base angle of the Dove prism exceeds 45 degrees.

9. An optical assembly, comprising:
a polarization beam combiner (PBC), a fast axis coupling lens (FCL), and a slow axis coupling lens (SCL) arranged to couple multiple laser beams into an optical fiber; and
an array that includes multiple optical devices arranged in a first row and a second row to generate the multiple laser beams, wherein the multiple optical devices each include:
a diode laser that includes a single emitter configured to emit a laser beam, of the multiple laser beams, in a beam propagation direction;
a fast axis collimation (FAC) lens arranged to collimate the laser beam in a fast axis;
a slow axis collimation (SAC) lens, arranged after the FAC lens, to collimate the laser beam in a slow axis;
a Dove prism arranged between the FAC lens and the SAC lens; and
a mirror, arranged after the SAC lens, to direct the laser beam toward the PBC, the FCL, and the SCL,
wherein the Dove prism includes an axis that is rotated 45 degrees relative to the single emitter such that an orientation of the fast axis and an orientation of the slow axis of the laser beam are rotated 90 degrees after the laser beam passes through the Dove prism.

10. The optical assembly of claim 9, wherein the multiple optical devices are equidistant from a heatsink.

11. The optical assembly of claim 9, wherein the orientation of the fast axis of the laser beam is parallel to the top surface of the single emitter and the orientation of the slow axis of the laser beam is perpendicular relative to the top surface of the single emitter after the laser beam passes through the Dove prism.

12. The optical assembly of claim 9, wherein the laser beam is wider in a first direction perpendicular to the top surface of the single emitter than a second direction parallel to the top surface of the single emitter after passing through the Dove prism.

13. The optical assembly of claim 9, further comprising:
a base, wherein the diode laser, the FAC lens, the SAC lens, the Dove prism, and the mirror of each of the multiple optical devices are mounted on the base.

14. The optical assembly of claim 9, wherein the Dove prism is mounted in one or more machined grooves formed in a surface mountable base.

15. The optical assembly of claim 9, wherein the Dove prism includes a 45 degree cut surface along one of four parallel edges for mounting on a surface mountable base.

16. The optical assembly of claim 9, wherein a base angle of the Dove prism exceeds 45 degrees.

17. An optical assembly, comprising:
a fast axis coupling lens (FCL) and a slow axis coupling lens (SCL) arranged to couple multiple laser beams into an optical fiber; and
an array that includes multiple optical devices arranged in a first row and a second row to generate the multiple laser beams, wherein the multiple optical devices each include:
a diode laser that includes a single emitter configured to emit a laser beam, of the multiple laser beams, in a beam propagation direction;
a fast axis collimation (FAC) lens arranged to collimate the laser beam in a fast axis;
a slow axis collimation (SAC) lens, arranged after the FAC lens, to collimate the laser beam in a slow axis;
a Dove prism arranged between the FAC lens and the SAC lens; and
a mirror, arranged after the SAC lens, to direct the laser beam toward the FCL and the SCL,
wherein the Dove prism includes an axis that is rotated relative to the single emitter such that an orientation of the fast axis and an orientation of the slow axis of the laser beam are rotated after the laser beam passes through the Dove prism.

18. The optical assembly of claim 17, wherein the multiple optical devices are equidistant from a heatsink.

19. The optical assembly of claim 18, further comprising:
a base, provided over the heatsink, wherein the diode laser, the FAC lens, the SAC lens, the Dove prism, and the mirror of each of the multiple optical devices are mounted on the base.

20. The optical assembly of claim 17, further comprising:
a wall structure separating a first subset of the multiple optical devices arranged in the first row from a second subset of the multiple optical devices arranged in the second row.
